(19) United States
(12) Patent Application Publication
(10) Pub. No.: US 2019/0189120 A1
(43) Pub. Date: Jun. 20, 2019

(54) METHOD FOR PROVIDING ARTIFICIAL INTELLIGENCE SERVICE DURING PHONE CALL AND ELECTRONIC DEVICE THEREOF

(71) Applicant: Samsung Electronics Co., Ltd., Suwon-si (KR)

(72) Inventors: Min Jung SOHN, Suwon-si (KR); Taek Soo CHUN, Suwon-si (KR); Yong Ho KIM, Suwon-si (KR); Eun Hye KIM, Suwon-si (KR); Chul Ho HAN, Suwon-si (KR); Sun Ah KIM, Suwon-si (KR)

(21) Appl. No.: 16/213,501

(22) Filed: Dec. 7, 2018

(30) Foreign Application Priority Data
Dec. 8, 2017 (KR) 10-2017-0168005

(51) Int. Cl. G10L 15/22; G06F 3/16

(52) U.S. Cl. CPC G10L 15/22; G10L 2015/226; G10L 2015/223; G06F 3/167

(57) ABSTRACT

An apparatus and method for providing an artificial intelligence service during a phone call in an electronic device are provided. The electronic device includes a communication module, at least one sound output device, at least one microphone, at least one processor, and a memory. The at least one processor is configured to connect a call with another electronic device through the communication module. In response to receiving a voice command for an artificial intelligence service, the at least one processor is further configured to identify an output mode, based on at least one of information related with the artificial intelligence service or mutual relation information with the other electronic device. The at least one processor is also configured to output a response signal corresponding to the voice command, based on the output mode.

### CROSS-REFERENCE TO RELATED APPLICATION

This application is based on and claims priority under 35 U.S.C. § 119 to Korean Patent Application No. 10-2017-0168005, filed on “Dec. 8, 2017”, in the Korean Intellectual Property Office, the disclosure of which is incorporated by reference herein in its entirety.

### BACKGROUND

### 1. Field

Various embodiments of the present invention relate to an apparatus and method for providing an artificial intelligence service during a phone call in an electronic device.

### 2. Description of Related Art

With the growth of digital technologies, various types of electronic devices such as mobile communication terminals, Personal Digital Assistants (PDAs), electronic organizers, smart phones, tablet Personal Computers (PCs), wearable devices, etc. are being used.

An artificial intelligence (AI) system, a computer system implementing an intelligence of a human level, can refer a system in which a machine advances by learning and judging by itself unlike a rule-based smart system. As being used, the artificial intelligence system can be improved in recognition rate and can get to more exactly understand a user taste. Thus, the existing rule-based smart system is gradually being substituted with the artificial intelligence system.

The above information is presented as background information only to assist with an understanding of the present disclosure. No determination has been made, and no assertion is made, as to whether any of the above might be applicable as prior art with regard to the present disclosure.

### SUMMARY

An electronic device can provide an artificial intelligence service, based on a voice command obtained through a voice recognition technology. For example, the voice recognition technology can detect a voice command corresponding to a feature of an acoustic speech signal that the electronic device obtains through a sound sensor such as a microphone. The electronic device can provide the artificial intelligence service such as mobile search, schedule management, making a phone call, a memo, music play or the like, on the basis of the user's voice command obtained through the voice recognition technology.

The electronic device can provide the artificial intelligence service in a condition of providing a text-based service. For example, the electronic device can activate an artificial intelligence agent, based on a user input (e.g., a voice command), in course of a messenger service provision, thereby providing the artificial intelligence service such as mobile search, phone number search, a memo or the like corresponding to the user input.

The electronic device needs a way for providing the artificial intelligence service in various use environments as well as the text-based service. For example, the electronic device may need a way for providing the artificial intelligence service in a condition of providing a voice-based service such as a call function.

Various embodiments of the present disclosure relate to an apparatus and method for providing an artificial intelligence service during a phone call in an electronic device.

According to various embodiments of the present disclosure, an electronic device includes a communication module, at least one sound output device, at least one microphone, at least one processor, and a memory electrically coupled with the processor. The memory includes instructions of, at execution, instructing the processor to connect a call with another electronic device through the communication module, and in response to receiving a voice command for an artificial intelligence service, identify an output mode, based on at least one of information related with the artificial intelligence service or mutual relation information with the another electronic device, and output a response signal corresponding to the voice command, based on the output mode.

According to various embodiments of the present disclosure, a method for operating in an electronic device includes connecting a call with another electronic device, and in response to receiving a voice command for an artificial intelligence service, identifying an output mode, based on at least one of information related with the artificial intelligence service or mutual relation information with the another electronic device, and outputting a response signal corresponding to the voice command, based on the output mode.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an electronic device for providing an artificial intelligence service within a network environment according to various embodiments of the present disclosure;

FIG. 2 illustrates a block diagram of an electronic device for providing an artificial intelligence service during a phone call according to various embodiments of the present disclosure;

FIG. 3 illustrates a construction of a system for providing an artificial intelligence service during a phone call by using a separate network according to various embodiments of the present disclosure;

FIG. 4 illustrates a block diagram of an electronic device for providing an artificial intelligence service during a phone call by using a separate network according to various embodiments of the present disclosure;

FIG. 5 illustrates a construction of a system for providing an artificial intelligence service during a phone call by using one network according to various embodiments of the present disclosure;

FIG. 6 illustrates a block diagram of an electronic device for providing an artificial intelligence service during a phone call by using one network according to various embodiments of the present disclosure;

FIG. 7 illustrates a flowchart for providing an artificial intelligence service during a phone call in an electronic device according to various embodiments of the present disclosure;

FIG. 8 illustrates a flowchart for activating an artificial intelligence agent in an electronic device according to various embodiments of the present disclosure;

FIGS. 9A-9C illustrate a construction for activating an artificial intelligence agent by using a physical button according to various embodiments of the present disclosure;

FIGS. 10A-10D illustrate a construction for activating an artificial intelligence agent by using a software button according to various embodiments of the present disclosure;

FIG. 11 illustrates a flowchart for identifying an output mode in an electronic device according to various embodiments of the present disclosure;

FIG. 12 illustrates a flowchart for identifying an output mode, based on a service policy in an electronic device according to various embodiments of the present disclosure;

FIG. 13 illustrates a flowchart for outputting a response of an agent, based on an output mode in an electronic device according to various embodiments of the present disclosure; and

FIG. 14 illustrates a flowchart for outputting a response of an agent by using an external output device in an electronic device according to various embodiments of the present disclosure.

### DETAILED DESCRIPTION

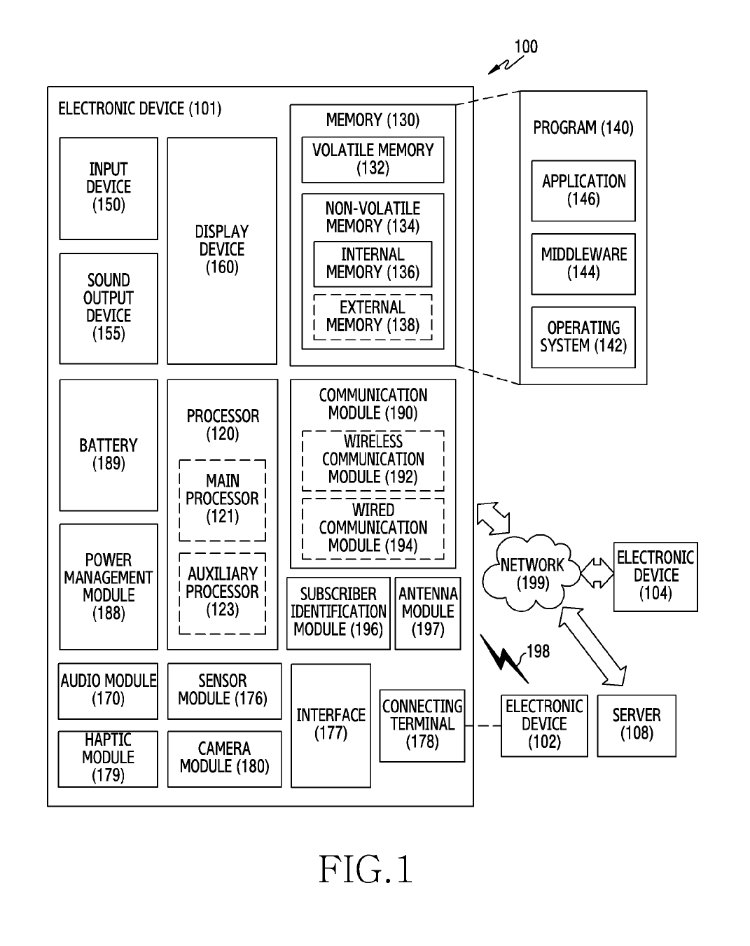

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Various embodiments of the present disclosure are described below in detail with reference to the accompanying drawings. And, in describing an embodiment of the present disclosure, related well-known functions or constructions are not described in detail since they would obscure the gist of the present disclosure in unnecessary detail. And, the terms described below, which are terms defined considering functions of the present disclosure, may be modified according to user and operator's intention or practice, etc. Therefore, the definition should be given on the basis of the content throughout the present specification.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wired) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wired) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

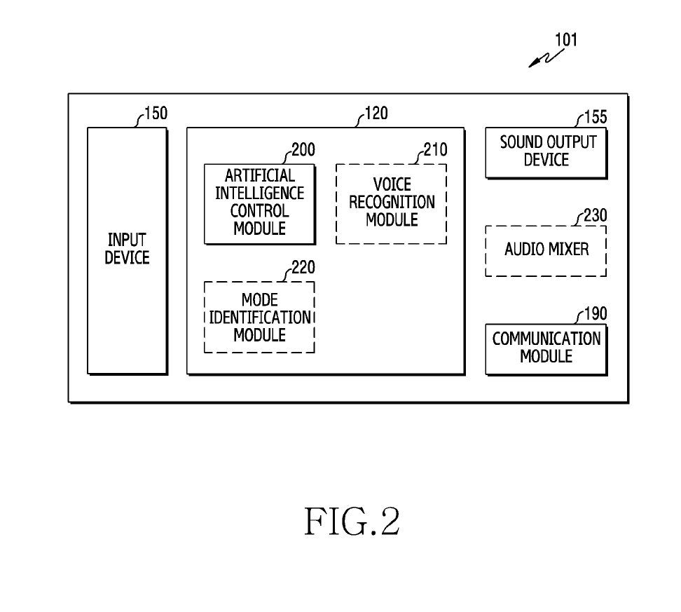

FIG. 2 illustrates a block diagram of an electronic device for providing an artificial intelligence service during a phone call according to various embodiments of the present disclosure. In the following description, the electronic device 101 may include at least part of the electronic device 101 of FIG. 1. In the following description, a detailed description for an operation of a module overlapped with a construction of FIG. 1 is omitted.

Referring to FIG. 2, the electronic device 101 may include the processor 120, the input device 150, the sound output device 155, the communication module 190 and an audio mixer 230. In the following description, at least some functions of modules (e.g., a voice recognition module 210, a mode identification module 220 and the audio mixer 230) shown in dotted lines may be limited or omitted according to an embodiment as well.

According to an embodiment, the processor 120 may control the communication module 190 to provide a phone call service with a counterpart electronic device (e.g., the electronic device 104). For example, the processor 120 may control the communication module 190 to connect a communication link with the counterpart electronic device. The processor 120 may control the communication module 190 to transmit and/or receive a voice signal through the communication link with the counterpart electronic device.

According to an embodiment, an artificial intelligence control module 200 may activate an artificial intelligence agent (e.g., the server 108), based on a user input (e.g., a voice command, a physical button input and/or a soft button input) obtained through the input device 150 (e.g., a touch screen, a microphone, a physical button, etc.) during a phone call with the counterpart electronic device. As an example, in response to obtaining a voice command corresponding to the calling of the artificial intelligence agent during a phone call connection with the counterpart electronic device, the artificial intelligence control module 200 may control the communication module 190 to connect a communication link with the artificial intelligence agent. As an example, in response to an artificial intelligence service provision menu being activated during a phone call, the artificial intelligence control module 200 may maintain an active state. In response to the artificial intelligence service provision menu being inactivated during the phone call, the artificial intelligence control module 200 may be inactivated.

According to an embodiment, the voice recognition module 210 may obtain a voice command from audio data obtained through the input device 150. For example, the voice recognition module 210 may obtain the voice command, through pre-processing (e.g., noise cancellation) of the audio data obtained through the input device 150, text transformation (e.g., automatic speech recognition (ASR)), and natural language recognition (e.g., natural language understanding (NLU)). As an example, the voice recognition module 210 may obtain a voice command for an artificial intelligence service from audio data which is received before or after a voice command corresponding to the calling of the artificial intelligence agent (e.g., the server 108) through the input device 150 (e.g., a microphone).

According to an embodiment, the mode identification module 220 may identify an output mode of an artificial intelligence service, based on at least one of information (e.g., a voice command or a response of an agent) related with the artificial intelligence service or a mutual relation with a counterpart electronic device. For example, the mode identification module 220 may identify an output mode corresponding to at least one of the voice command for the artificial intelligence service or the response of the agent corresponding to the voice command, in a predefined table (e.g., database). As an example, the predefined table may include at least one of the voice command for setting in a non-public mode or the response of the agent. As an example, the predefined table may include an output mode for each voice command for providing the artificial intelligence service or the agent. For example, the mode identification module 220 may identify the output mode of the artificial intelligence service, based on intimacy levels of a user of the electronic device 101 and a user of the counterpart electronic device. As an example, the output mode corresponding to the intimacy level with the user of the counterpart electronic device may be identified through an intimacy level table. The intimacy level table may be refined based on a use history of the electronic device 101.

According to an embodiment, the mode identification module 220 may identify an output mode of an artificial intelligence service, based on a service policy of the electronic device 101. For example, in response to an output mode selected by a user and an output mode corresponding to information related with the artificial intelligence service being different from each other, the mode identification module 220 may identify the output mode of the artificial intelligence service, based on the service policy of the electronic device 101. As an example, in response to a service policy which prioritizes personal information protection being set, the mode identification module 220 may set, as the output mode of the artificial intelligence service, an output mode whose security level is high among the output mode selected by the user and the output mode corresponding to the information related with the artificial intelligence service. For example, in response to the output mode corresponding to the mutual relation with the counterpart electronic device and the output mode corresponding to the information related with the artificial intelligence service being different from each other, the mode identification module 220 may identify the output mode of the artificial intelligence service, based on the service policy of the electronic device 101. As an example, in response to a service policy which prioritizes information publication being set, the mode identification module 220 may set, as the output mode of the artificial intelligence service, an output mode whose security level is low among the output mode corresponding to the mutual relation with the counterpart electronic device and the output mode corresponding to the information related with the artificial intelligence service. As an example, the service policy of the electronic device 101 may be identified based on at least one of the kind of a voice command for the artificial intelligence service, a mutual relation with the counterpart electronic device, or a use history of the electronic device 101.

According to an embodiment, the audio mixer 230 may selectively mix audio data corresponding to a phone call service and audio data corresponding to an artificial intelligence service, based on an output mode of an artificial intelligence service. For example, the audio mixer 230 may mix a voice signal received from a counterpart electronic device (e.g., the electronic device 104) through the communication module 190 and a response signal of the agent, as one audio signal, and output through the sound output device 155. For example, in response to the output mode of the artificial intelligence service being a public mode, the audio mixer 230 may mix a voice signal received through the input device 150 and a response signal of the agent, as one audio signal, and control the communication module 190 to transmit to a counterpart electronic device. For example, in response to the output mode of the artificial intelligence service being a non-public mode, the audio mixer 230 may control the communication module 190 to transmit a user's voice signal received through the input device 150 to the counterpart electronic device. For example, in response to the output mode of the artificial intelligence service being a mosaic mode, the audio mixer 230 may mix a user's voice signal received through the input device 150 and at least part of a response signal of the agent, as one audio signal, and control the communication module 190 to transmit to the counterpart electronic device. As an example, the audio mixer 230 may replace a main phrase restricting transmission to the counterpart electronic device with another audio signal, or may batch process the same. As an example, the mosaic mode may include an output mode of restricting the publication of the main phrase among the response signal of the agent.

According to various embodiments of the present disclosure, the electronic device may provide an artificial intelligence service, based on a command by a different kind of input such as a text or gesture as well as a voice.

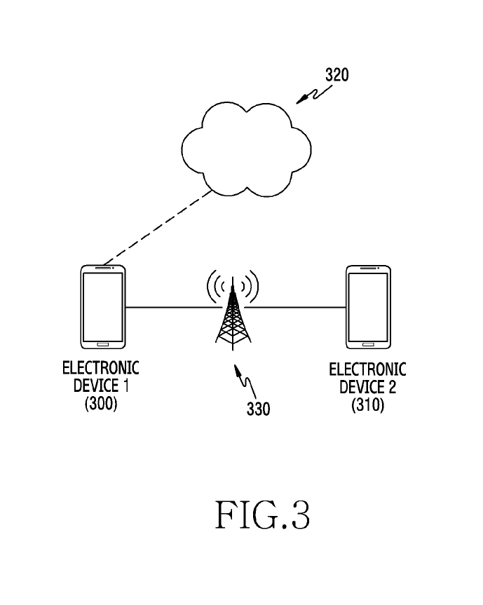

FIG. 3 illustrates a construction of a system for providing an artificial intelligence service during a phone call by using a separate network according to various embodiments of the present disclosure.

According to an embodiment, a communication channel for an artificial intelligence service of an electronic device 1 300 (e.g., the electronic device 101 of FIG. 1) and a communication channel for a phone call with an electronic device 2 310 (e.g., the electronic device 104 of FIG. 1) may be separated from each other. For example, the electronic device 1 300 may set the communication channel for the phone call with the electronic device 2 310 through a base station 330. The electronic device 1 300 may set a separate communication channel with an artificial intelligence agent 320 (e.g., the server 108 of FIG. 1) for the sake of the artificial intelligence service. As an example, the artificial intelligence agent 320 may provide the artificial intelligence service to the electronic device 1 300 by using a cloud linked with the electronic device 1 300. As an example, the communication channel for the phone call may be set as a wired link or wireless link.

According to an embodiment, in response to providing an artificial intelligence service during a phone call, the electronic device 1 300 may mix audio data for a phone call service and audio data for the artificial intelligence service. For example, the electronic device 1 300 may mix audio data provided from the electronic device 2 310 and audio data provided from the artificial intelligence agent 320, as one audio data. As an example, the mixed audio data may be outputted through a speaker (e.g., the sound output device 155 of FIG. 1) of the electronic device 1 300. For example, the electronic device 1 300 may selectively mix audio data received through a microphone (e.g., the input device 150 of FIG. 1) and audio data provided from the artificial intelligence agent 320, based on an output mode of the artificial intelligence service. As an example, in response to being a public mode, the electronic device 1 300 may mix audio data received through the microphone and audio data provided from the artificial intelligence agent 320, as one audio data. The mixed audio data may be transmitted to the electronic device 2 310 through the base station 330. As an example, in response to being a non-public mode, the electronic device 1 300 may restrict the mixing of the audio data received through the microphone and the audio data provided from the artificial intelligence agent 320. In this case, the electronic device 1 300 may transmit the audio data received through the microphone, to the electronic device 2 310. As an example, in response to being a mosaic mode, the electronic device 1 300 may mix at least part of the audio data provided from the artificial intelligence agent 320 and the audio data received through the microphone. The mixed audio data may be transmitted to the electronic device 2 310 through the base station 330. The at least part of the audio data provided from the artificial intelligence agent 320 may include the remaining audio data excepting a main phrase among the audio data provided from the artificial intelligence agent 320.

According to various embodiments of the present disclosure, in response to a communication channel for an artificial intelligence service of the electronic device 1 300 and a communication channel for a phone call with the electronic device 2 310 being separated from each other, the artificial intelligence agent 320 may mix audio data. For example, the artificial intelligence agent 320 may mix audio data for the phone call and audio data for the artificial intelligence service, and transmit to the electronic device 1 300 or the electronic device 2 310 through the base station 330.

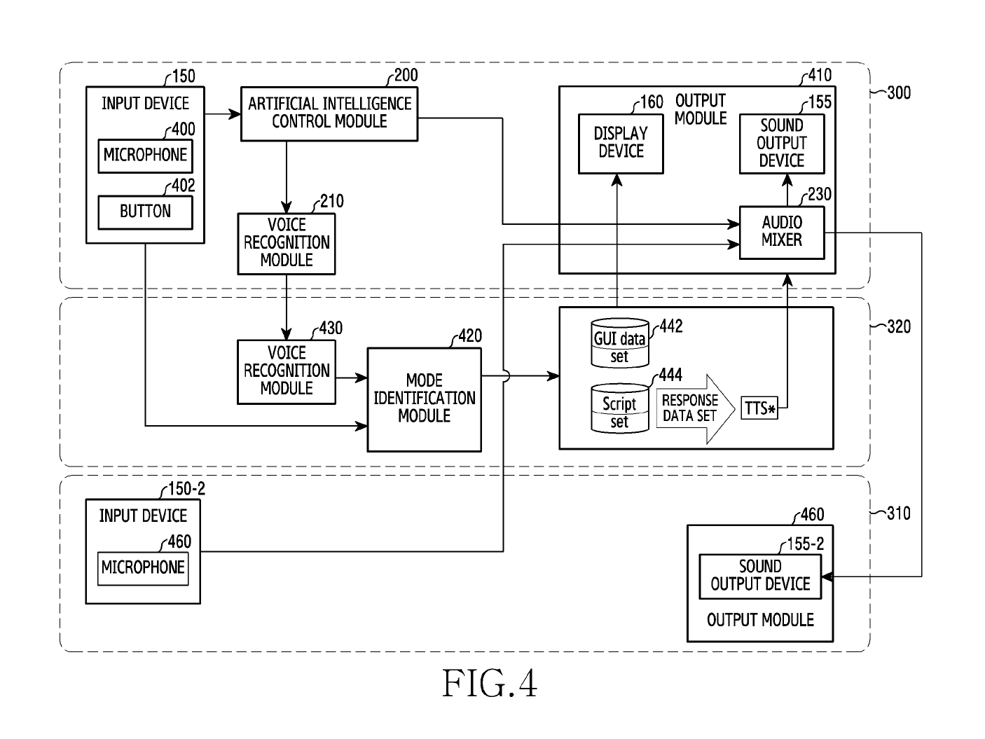

FIG. 4 illustrates a block diagram of an electronic device for providing an artificial intelligence service during a phone call by using a separate network according to various embodiments of the present disclosure. In the following description, a detailed description for an operation of a module overlapped with a construction of FIG. 1 or FIG. 2 is omitted.

According to an embodiment, the input device 150 may include a microphone 400 for collecting an audio signal and a physical button 402. As an example, the physical button 402 may include at least one of a home button, a volume adjustment button, a power button, or a hardware button corresponding to an artificial intelligence service.

According to an embodiment, the artificial intelligence control module 200 may obtain a voice command corresponding to the calling of the artificial intelligence agent 320 (e.g., the server 108 of FIG. 1) from audio data obtained through the input device 150 (e.g., the microphone) during a phone call with a counterpart electronic device through the communication module 190. In response to obtaining the voice command corresponding to the calling of the artificial intelligence agent 320, the artificial intelligence control module 200 may control the communication module 190 to transmit a calling signal to the artificial intelligence agent 320.

According to an embodiment, the voice recognition module 210 may perform pre-processing (e.g., noise cancellation) and text transformation (ASR) for audio data obtained through the input device 150. As an example, the voice recognition module 210 may transmit text transformation information corresponding to audio data, to the artificial intelligence agent 320.

According to an embodiment, a voice recognition module 430 of the artificial intelligence agent 320 may obtain a voice command for an artificial intelligence service, through natural language understanding (NLU) for text transformation information corresponding to audio data provided from the voice recognition module 210 of the electronic device 1 300.

According to an embodiment, a mode identification module 420 of the artificial intelligence agent 320 may identify an output mode of the electronic device 1 300 for the artificial intelligence service, based on at least one of a voice command provided from the voice recognition module 430 or a mutual relation with a busy counterpart electronic device. For example, the mode identification module 420 may identify the output mode of the artificial intelligence service, in additional consideration of a service policy of the electronic device 1 300. As an example, the service policy of the electronic device 1 300 may be identified based on at least one of the kind of a voice command for the artificial intelligence service, a mutual relation with the counterpart electronic device, or a use history of the electronic device 1 300.

According to an embodiment, an output module 440 of the artificial intelligence agent 320 may transmit a response signal corresponding to a voice command provided from the voice recognition module 430, to the electronic device 1 300. For example, the output module 440 may transmit graphic data 442 corresponding to the voice command provided from the voice recognition module 430, to the electronic device 1 300. The output module 440 may transmit audio data 444 corresponding to the voice command provided from the voice recognition module 430, to the electronic device 1 300. The output module 440 may transform (i.e., text to speech (TTS)) the audio data 444 corresponding to the voice command provided from the voice recognition module 430, into voice data, and transmit to the electronic device 1 300.

According to an embodiment, the audio mixer 230 of the electronic device 1 300 may selectively mix audio data corresponding to a phone call service and audio data provided from the artificial intelligence agent 320, based on an output mode of an artificial intelligence service. As an example, the audio data corresponding to the phone call service may include at least one of audio data corresponding to a user of the electronic device 1 300 collected through the input device 150 (e.g., a microphone) or audio data provided from the electronic device 2 310. As an example, the output mode of the artificial intelligence service may include a plurality of output modes, based on a public level of the audio data of the artificial intelligence service. As an example, the output mode of the artificial intelligence service may be divided into four as in Table 1 below.

TABLE 1

| output mode | description |
|---|---|
| Public mode | The caller and the other party listen to the contents of the |
| | calling and the conversation with the agent. |
| | Available to share visual data |
| Mosaic mode | Only the key phrases of the conversation with the |
| | agent are disclosed only to the caller. |
| Master mode | Discloses the caller's command to the other party in the |
| | conversation with the agent, and releases the response of |
| | the agent only to the caller |
| Non-public | Disclose conversations with agent to caller only |
| mode | |

According to an embodiment, the display device 160 of the electronic device 1 300 may display the graphic data 442 provided from the artificial intelligence agent 320. The sound output device 155 of the electronic device 1 300 may output audio data provided from the audio mixer 230.

According to an embodiment, an output module 460 of the electronic device 2 310 may output the audio data provided from the audio mixer 230 of the electronic device 1 300.

According to an embodiment, the output module 460 of the electronic device 2 310 may output at least part of the graphic data 442 outputted through the display device 160 of the electronic device 1 300. For example, the electronic device 1 300 may transmit, to the electronic device 2 310, an address (e.g., a uniform resource locator (URL)) of a service related with the graphic data 442 outputted through the display device 160 by using a message or a separate control signal. The electronic device 2 310 may receive at least part of the graphic data 442 outputted through the display device 160 of the electronic device 1 300 from an external server, based on an address provided from the electronic device 1 300. The graphic data received from the external server may be displayed through the output module 460 (e.g., a display device) of the electronic device 2 310.

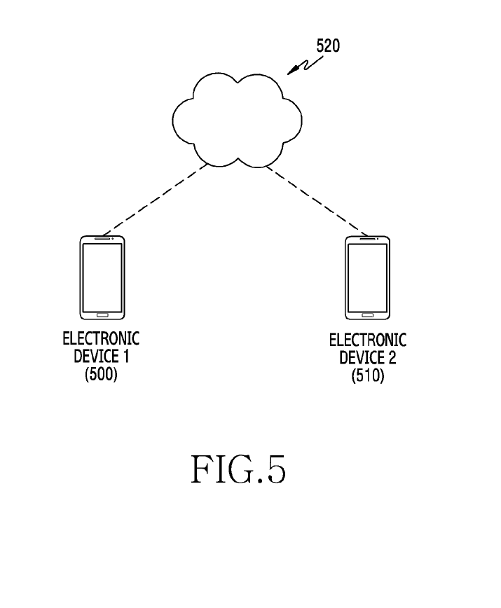

FIG. 5 illustrates a construction of a system for providing an artificial intelligence service during a phone call by using one network according to various embodiments of the present disclosure.

According to an embodiment, a communication channel for an artificial intelligence service of an electronic device 1 500 (e.g., the electronic device 101 of FIG. 1) and a communication channel for a phone call with an electronic device 2 510 (e.g., the electronic device 104 of FIG. 1) may be identical with each other. For example, the electronic device 1 500 may connect to an artificial intelligence agent 520 (e.g., the server 108 of FIG. 1) by using a cloud linked with the electronic device 1 500, to provide the artificial intelligence service. The electronic device 1 500 may establish the communication channel for the phone call with the electronic device 2 510 through a cloud service.

According to an embodiment, the artificial intelligence agent 520 may mix audio data for a phone call service and audio data for an artificial intelligence service. For example, the artificial intelligence agent 520 may mix audio data provided from the electronic device 2 510 and the audio data (e.g., a response signal) for the artificial intelligence service, as one audio data. The mixed audio data may be transmitted to the electronic device 1 500. For example, the artificial intelligence agent 520 may selectively mix audio data received from the electronic device 1 500 and the audio data for the artificial intelligence service, based on an output mode of the electronic device 1 500 for the artificial intelligence service. As an example, in response to the output mode of the electronic device 1 500 for the artificial intelligence service being a public mode, the artificial intelligence agent 520 may mix the audio data provided from the electronic device 1 500 and the audio data for the artificial intelligence service, as one audio data. The mixed audio data may be transmitted to the electronic device 2 510. As an example, in response to the output mode of the electronic device 1 500 for the artificial intelligence service being a non-public mode, the artificial intelligence agent 520 may restrict the mixing of the audio data provided from the electronic device 1 500 and the audio data for the artificial intelligence service. In this case, the artificial intelligence agent 520 may transmit the audio data provided from the electronic device 1 500, to the electronic device 2 510. As an example, in response to the output mode of the electronic device 1 500 for the artificial intelligence service being a mosaic mode, the artificial intelligence agent 520 may mix part of the audio data for the artificial intelligence service and the audio data provided from the electronic device 1 500, as one audio data. The mixed audio data may be transmitted to the electronic device 2 510. The part of the audio data for the artificial intelligence service may include the remaining response signal excepting a main phrase among a response signal of the artificial intelligence agent 520.

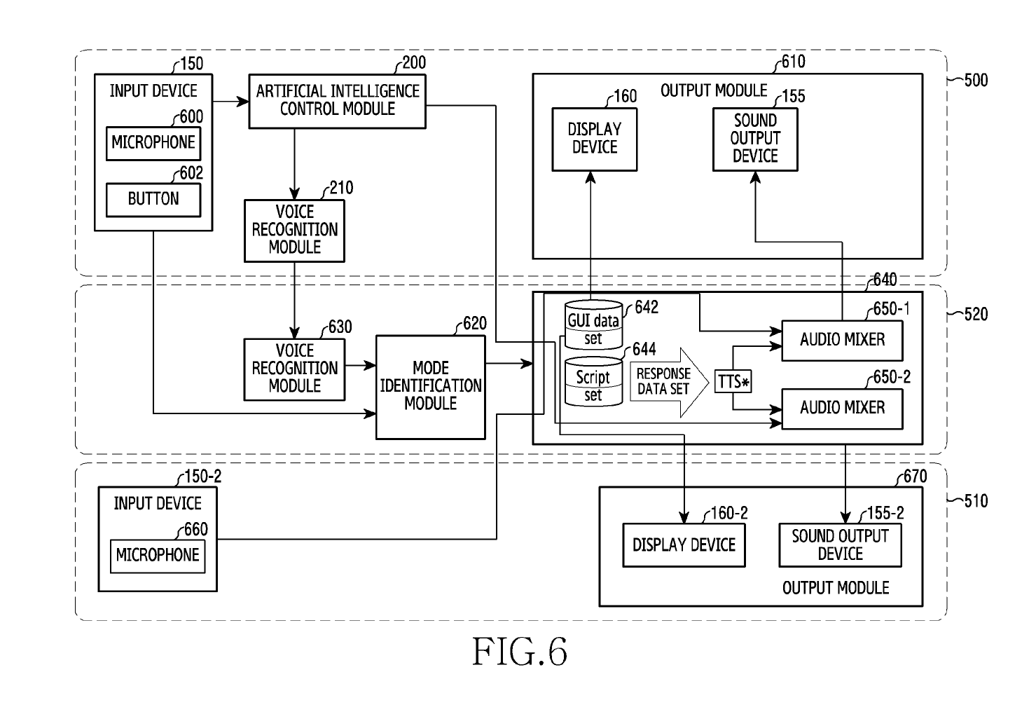

FIG. 6 illustrates a block diagram of an electronic device for providing an artificial intelligence service during a phone call by using one network according to various embodiments of the present disclosure. In the following description, a detailed description for an operation of a module overlapped with a construction of FIG. 4 is omitted.

According to an embodiment, the input device 150 may include a microphone 600 for collecting an audio signal and a physical button 602.

According to an embodiment, the artificial intelligence control module 200 of the electronic device 1 500 may activate the artificial intelligence service, by transmitting a calling signal to the artificial intelligence agent 320 through the communication module 190, based on an artificial intelligence service activation event. As an example, in response to obtaining a voice command corresponding to the calling of the artificial intelligence agent 520 (e.g., the server 108 of FIG. 1) from audio data obtained through the input device 150 (e.g., a microphone) during a phone call with a counterpart electronic device, the artificial intelligence control module 200 may identify that the artificial intelligence service activation event takes place.

According to an embodiment, the artificial intelligence agent 520 may obtain a voice command for an artificial intelligence service from audio data obtained through the input device 150 by using the voice recognition module 210 of the electronic device 1 500 and a voice recognition module 630.

According to an embodiment, a mode identification module 620 of the artificial intelligence agent 520 may identify an output mode of the electronic device 1 500 for the artificial intelligence service, based on at least one of a voice command for the artificial intelligence service obtained from the voice recognition module 630 or a mutual relation with a busy counterpart electronic device. Additionally, the mode identification module 620 may identify an output mode of the artificial intelligence service, in additional consideration of a service policy of the electronic device 1 500.

According to an embodiment, an output module 640 of the artificial intelligence agent 520 may transmit graphic data 642 corresponding to a voice command provided from the voice recognition module 430, to at least one of the electronic device 1 500 or the electronic device 2 510.

According to an embodiment, the output module 640 of the artificial intelligence agent 520 may selectively mix audio data 644 corresponding to a voice command provided from the voice recognition module 630, and transmit to at least one of the electronic device 1 500 or the electronic device 2 510. For example, an audio mixer 650-1 may mix a voice signal received from the electronic device 2 510 (e.g., the electronic device 104) and a response signal based on the audio data 644 of the agent as one audio signal, and transmit to the output module 610 of the electronic device 1 500. For example, in response to an output mode of the electronic device 1 500 being a public mode, an audio mixer 650-2 may mix a voice signal received from the electronic device 1 500 and the response signal based on the audio data 644 of the agent as one audio signal, and transmit to an output module 670 of the electronic device 2 510. For example, in response to the output mode of the electronic device 1 500 being a non-public mode, the audio mixer 650-2 may restrict the mixing of the voice signal received from the electronic device 1 500 and the response signal based on the audio data 644 of the agent. That is, the audio mixer 650-2 may transmit the user's voice signal received from the electronic device 1 500, to the electronic device 2 510. As an example, the output module 640 may transform (i.e., TTS) the audio data 644 corresponding to the voice command provided from the voice recognition module 630 into voice data, and transmit to the audio mixers 650-1 and 650-2.

According to various embodiments of the present disclosure, an electronic device may include a communication module, at least one sound output device, at least one microphone, at least one processor, and a memory electrically coupled with the processor. The memory may store instructions of, at execution, instructing the processor to connect a call with another electronic device through the communication module, and in response to receiving a voice command for an artificial intelligence service, identify an output mode, based on at least one of information related with the artificial intelligence service or mutual relation information with the another electronic device, and output a response signal corresponding to the voice command, based on the output mode.

According to various embodiments, the instructions may include an instruction of instructing the at least one processor to identify the output mode, based on at least one of personal information included in the information related with the artificial intelligence service or the existence or non-existence of the response signal corresponding to the voice command.

According to various embodiments, the information related with the artificial intelligence service may include at least one of the voice command for the artificial intelligence service or the response signal corresponding to the voice command.

According to various embodiments, the instructions may include an instruction of instructing the at least one processor to identify the output mode, based on an intimacy level with a user of the another electronic device.

According to various embodiments, the intimacy level with the user of the another electronic device may be set based on at least one of the storing or non-storing of a phone number of the another electronic device, the setting or non-setting of a favorite of the phone number of the another electronic device, a phone call recursion, a message transmission and/or reception recursion, a phone call time point, a message transmission and/or reception time point, a phone call time, or relation setting information with the user of the another electronic device.

According to various embodiments, the instructions may include an instruction of instructing the at least one processor to, in response to an output mode corresponding to the information related with the artificial intelligence service and an output mode corresponding to the mutual relation information with the another electronic device being different from each other, select any one of the output mode corresponding to the information related with the artificial intelligence service and the output mode corresponding to the mutual relation information with the another electronic device, as the output mode of the electronic device, based on a service policy of the electronic device.

According to various embodiments, the service policy may be identified based on at least one of the kind of the voice command, the mutual relation information with the other electronic device, or a use history of the electronic device.

According to various embodiments, the electronic device may further include an audio mixer, and the instructions may include an instruction of instructing the at least one processor to control the audio mixer to mix the response signal corresponding to the voice command and an audio signal received from the another electronic device through the communication module, and control the audio mixer to selectively mix the response signal corresponding to the voice command and an audio signal received through the at least one microphone, based on the output mode.

According to various embodiments, the instructions may include an instruction of instructing the at least one processor to, in response to the output mode being a public mode, control the audio mixer to mix at least part of the response signal corresponding to the voice command and an audio signal received through the at least one microphone, and control the communication module to transmit the mixed audio signal to the another electronic device, and in response to the output mode being a non-public mode, restrict the mixing of the response signal corresponding to the voice command and the audio signal received through the at least one microphone, and control the communication module to transmit at least part of the audio signal received through the at least one microphone to the another electronic device.

According to various embodiments, the instructions may include an instruction of instructing the at least one processor to transmit the response signal corresponding to the voice command to an external output device operatively coupled with the electronic device, and output, through the at least one sound output device, the audio signal which is received from the another electronic device through the communication module.

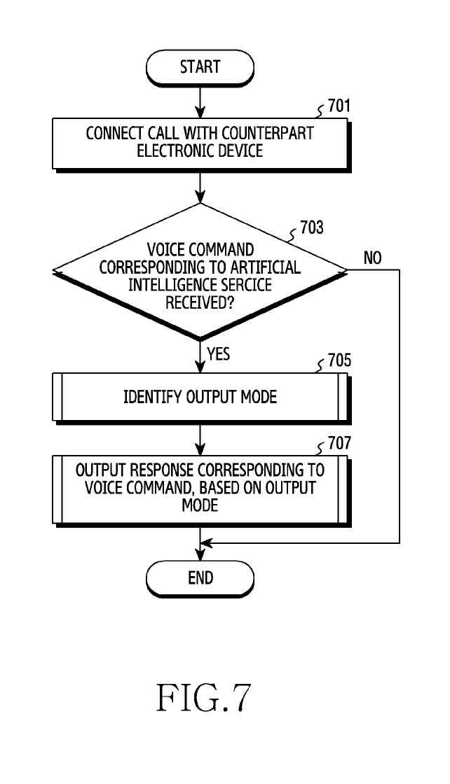

FIG. 7 illustrates a flowchart for providing an artificial intelligence service during a phone call in an electronic device according to various embodiments of the present disclosure. In the following description, the electronic device may include the whole or at least part of the electronic device 101 of FIG. 1 or FIG. 2.

Referring to FIG. 7, in operation 701, the electronic device may connect a phone call with a counterpart electronic device. For example, in response to receiving a call from the counterpart electronic device (e.g., the electronic device 104 of FIG. 1) through the communication module 190, the processor 120 may control at least one of the sound output device 155, the display device 160 or the haptic module 179 to output call reception notification information. In response to receiving an input for acceptance of call reception through the input device 150, the processor 120 may control the communication module 190 to connect a call with the counterpart electronic device. For example, in response to a call connection event taking place based on a user input received through the input device 150, the processor 120 may control the communication module 190 to transmit a call from the counterpart electronic device (e.g., the electronic device 104 of FIG. 1) for call connection. In response to receiving a call acceptance signal through the communication module 190, the processor 120 may provide a phone call service with the counterpart electronic device.

In operation 703, the electronic device may identify whether a voice command for an artificial intelligence service is obtained during the phone call with the counterpart electronic device. For example, the processor 120 (e.g., the artificial intelligence control module 200 of FIG. 2) may identify whether a voice command corresponding to the calling of an artificial intelligence agent (e.g., the server 108 of FIG. 1) is obtained from audio data for the phone call with the counterpart electronic device. In response to obtaining the voice command corresponding to the calling of the artificial intelligence agent, the processor 120 (e.g., the voice recognition module 210 of FIG. 2) may obtain a voice command for the artificial intelligence service from audio data received before or after the corresponding voice command. For example, the processor 120 (e.g., the artificial intelligence control module 200 of FIG. 2) may identify whether an input of a physical button corresponding to the calling of the artificial intelligence agent (e.g., the server 108 of FIG. 1) is obtained during the phone call with the counterpart electronic device. In response to obtaining the input of the physical button corresponding to the calling of the artificial intelligence agent, the processor 120 (e.g., the voice recognition module 210 of FIG. 2) may obtain a voice command for the artificial intelligence service from received audio data from a time point of obtaining the input of the physical button.

In operation 705, in response to obtaining the voice command for the artificial intelligence service during the phone call with the counterpart electronic device, the electronic device may identify an output mode of the artificial intelligence service, based on at least one of information related with the artificial intelligence service or a mutual relation with the counterpart electronic device. For example, the processor 120 (e.g., the mode identification module 220 of FIG. 2) may identify whether a voice command matching with the voice command for the artificial intelligence service exists in a table corresponding to a non-public mode stored in the memory 130. In response to obtaining the voice command matching with the voice command for the artificial intelligence service from the table corresponding to the non-public mode, the processor 120 may set the output mode of the artificial intelligence service as a non-public mode or a master mode. In response to the voice command matching with the voice command for the artificial intelligence service not existing in the table corresponding to the non-public mode, the processor 120 may set the output mode of the artificial intelligence service as a public mode or a mosaic mode. For example, the processor 120 (e.g., the mode identification module 220 of FIG. 2) may obtain an output mode of the artificial intelligence service corresponding to an intimacy level between a user of the electronic device 101 and a user of the counterpart electronic device from an intimacy level table stored in the memory 130. As an example, the intimacy level table may be refined based on a use history of the electronic device 101. For example, in response to output modes corresponding to respective variables identifying the output mode of the artificial intelligence service being different from each other, the processor 120 may identify an output mode of the electronic device 101 for the artificial intelligence service, based on a service policy of the electronic device 101. As an example, the variable identifying the output mode of the artificial intelligence service may include at least one of information related with the artificial intelligence service, a mutual relation with the counterpart electronic device or a user input for output mode selection.

In operation 707, the electronic device may output a response of an agent corresponding to the voice command, based on the output mode of the electronic device for the artificial intelligence service. For example, in response to the output mode of the electronic device 101 being a public mode, the processor 120 may control the audio mixer 230 to mix a voice signal of a user received through the input device 150 and a response signal of the agent, as one audio signal. The audio mixer 230 may transmit the mixed audio signal to a counterpart electronic device through the communication module 190. For example, in response to the output mode of the electronic device 101 being a mosaic mode, the processor 120 may control the audio mixer 230 to mix the response signal of the agent whose main phrase is masked and a voice signal of a user received through the input device 150, as one audio signal. The audio mixer 230 may transmit the mixed audio signal to the counterpart electronic device through the communication module 190. As an example, the main phrase may include at least one of bank information (e.g., an account number, a balance, etc.), a personal identification number, a password, or body information (e.g., a weight, a heart rate) of the user. For example, in response to the output mode of the electronic device 101 being a master mode or a non-public mode, the processor 120 may restrict the mixing of the response signal of the agent and the user's voice signal received through the input device 150. As an example, in response to being the master mode, the processor 120 may control the communication module 190 to transmit the user's voice signal received through the input device 150, to the counterpart electronic device. As an example, in response to being the non-public mode, the processor 120 may control the communication module 190 to transmit at least part of the user's voice signal received through the input device 150, to the counterpart electronic device. The at least part of the user's voice signal received through the input device 150 may include the remaining voice signal excepting user's calling information corresponding to an artificial intelligence agent among the user's voice signal received through the input device 150.

According to an embodiment, the electronic device may transform one response corresponding to a user's voice command to correspond to an output mode of the electronic device, and transmit to the counterpart electronic device. For example, the processor 120 may transform the response of the agent, based on an output mode of the electronic device 101 as in Table 2 below.

TABLE 2

| | | Agent's response | | |
|---|---|---|---|---|
| | Electronic | | | Master mode or |
| User utterance | device | Public mode | Mosaic mode | non-public mode |
| “how is the | Caller | Tomorrow's | Tomorrow's | Tomorrow's |
| weather | electronic | weather is fine. | weather is fine. | weather is fine. |
| tomorrow?” | device | | | |
| | Receiver | Tomorrow's | Tomorrow's | [Private message, |
| | electronic | weather is fine. | weather is -beep-. | background |
| | device | | | music, beep |
| | | | | sound] |
| “give me a | Caller | There are two | There are two | There are two |
| weekend | electronic | meetings this | meetings this | meetings this |
| schedule” | device | weekend. | weekend. | weekend. |
| | Receiver | There are two | There are -beep- | [Private message, |
| | electronic | meetings this | meetings this | background |
| | device | weekend. | weekend. | music, beep |
| | | | | sound] |
| “How much is the | Caller | The balance is | The balance is | The balance is |
| bank balance?” | electronic | $123,456. | $123,456. | $123,456. |
| | device | | | |
| | Receiver | The balance is | The balance is - | [Private message, |
| | electronic | $123,456. | beep-. | background |
| | device | | | music, beep |
| | | | | sound] |

For example, in response to the output mode of the electronic device 101 being the public mode, the processor 120 may control at least one of the sound output device 155 or the display device 160 to output information identifying the publication or non-publication of the main phrase.

According to an embodiment, the electronic device may output responses of the agent which are different from each other by output mode of the electronic device. For example, the processor 120 may control to output responses of the agent which are different from each other by output mode of the electronic device 101, as in Table 3 below.

TABLE 3

| | | Agent's response | | |
|---|---|---|---|---|
| | Electronic | | | Master mode or |
| User utterance | device | Public mode | Mosaic mode | non-public mode |
| “how is the | Caller | Tomorrow's | Tomorrow's | Tomorrow's |
| weather | electronic | weather is fine. | weather is fine. | weather is fine. |
| tomorrow?” | device | | | |
| | Receiver | Tomorrow's | Tomorrow's | [Private message, |
| | electronic | weather is fine. | weather is -beep-. | background |
| | device | | | music, beep |
| | | | | sound] |
| “give me a | Caller | There are an | There are an | There are an |
| weekend | electronic | appointment with | appointment with | appointment with |
| schedule” | device | Mi-Jung at 9 AM | Mi-Jung at 9 AM | Mi-Jung at 9 AM |
| | | on the weekend | on the weekend | on the weekend |
| | | and an | and an | and an |
| | | appointment with | appointment with | appointment with |
| | | Sun-Young at 2 | Sun-Young at 2 | Sun-Young at 2 |
| | | PM in the | PM in the | PM in the |
| | | afternoon. | afternoon. | afternoon. |
| | Receiver | There are two | There are -beep- | [Private message, |
| | electronic | meetings this | meetings this | background |
| | device | weekend. | weekend. | music, beep |
| | | | | sound] |
| “How much is the | Caller | The balance is | The balance is | The balance is |
| bank balance?” | electronic | $123,456. | $123,456. | $123,456. |
| | device | | | |
| | Receiver | The balance is | there is a bank | [Private message, |
| | electronic | $123,456. | balance. | background |
| | device | | | music, beep |
| | | | | sound] |

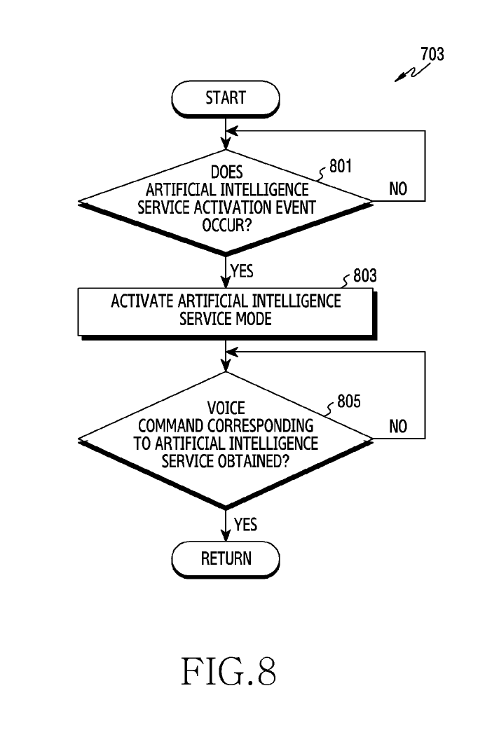

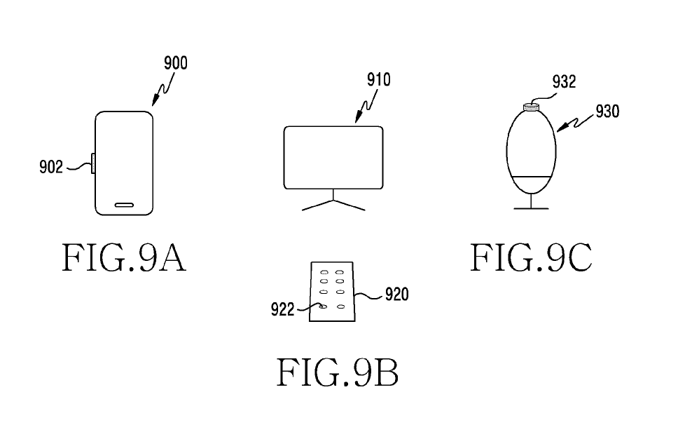

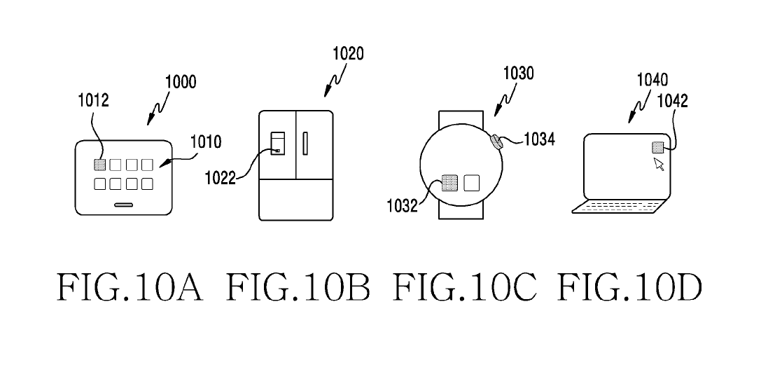

FIG. 8 illustrates a flowchart for activating an artificial intelligence agent in an electronic device according to various embodiments of the present disclosure. FIG. 9 illustrates a construction for activating the artificial intelligence agent by using a physical button according to various embodiments of the present disclosure. FIG. 10 illustrates a construction for activating the artificial intelligence agent by using a software button according to various embodiments of the present disclosure. The following description is made for an operation for obtaining a voice command for an artificial intelligence service in operation 703 of FIG. 7. In the following description, the electronic device may include the whole or at least part of the electronic device 101 of FIG. 1 or FIG. 2.

Referring to FIG. 8, in operation 801, in response to connecting a phone call with a counterpart electronic device (e.g., operation 701 of FIG. 7), the electronic device may identify whether an artificial intelligence service activation event occurs. For example, the processor 120 (e.g., the artificial intelligence control module 200 of FIG. 2) may identify whether an input of a physical button of the electronic device 101 corresponding to an artificial intelligence service is received. As an example, in response to the electronic device 101 being a smart phone 900 as in FIG. 9A, the processor 120 may identify whether an input of a physical button 902 corresponding to the artificial intelligence service in the smart phone 900 is received. As an example, in response to the electronic device 101 being a television 910 as in FIG. 9B, the processor 120 may identify whether an input of a physical button 922 corresponding to the artificial intelligence service in a remote controller 920 corresponding to the television 910 is received. As an example, in response to the electronic device 101 being a speaker 930 as in FIG. 9C, the processor 120 may identify whether an input of a physical button 932 corresponding to the artificial intelligence service in the speaker 930 is received. For example, the processor 120 may identify whether an input (e.g., a touch input) corresponding to a software button corresponding to the artificial intelligence service is received. As an example, in response to the electronic device 101 being a tablet 1000 as in FIG. 10A, the processor 120 may identify whether a touch input corresponding to an icon 1012 corresponding to the artificial intelligence service among a plurality of icons 1010 displayed on a display device (e.g., the display device 160 of FIG. 1) of the tablet 1000 is received. As an example, in response to the electronic device 101 being a refrigerator 1020 as in FIG. 10B, the processor 120 may identify whether a touch input corresponding to an icon 1022 corresponding to the artificial intelligence service displayed on a display device of the refrigerator 1020 is received. As an example, in response to the electronic device 101 being a wearable device 1030 as in FIG. 10C, the processor 120 may identify whether a selection input corresponding to an icon 1032 or physical button 1034 corresponding to the artificial intelligence service displayed on a display device of the wearable device 1030 is received. As an example, in response to the electronic device 101 being a notebook computer 1040 as in FIG. 10D, the processor 120 may identify whether a selection input corresponding to an icon 1042 corresponding to the artificial intelligence service displayed on a display device of the notebook computer 1040 is received. For example, the processor 120 may identify whether a voice command corresponding to the calling of an artificial intelligence agent is obtained from audio data received through the input device 150.

In response to the artificial intelligence service activation event not occurring, the electronic device may again identify whether the artificial intelligence service activation event occurs during a phone call with a counterpart electronic device.

In operation 803, in response to the artificial intelligence service activation event occurring, the electronic device may activate an artificial intelligence service mode. For example, the processor 120 may control the communication module 190 to transmit an active signal to the artificial intelligence agent (e.g., the server 108 of FIG. 1).

In operation 805, the electronic device may identify whether a voice command corresponding to the artificial intelligence service is obtained. For example, the processor 120 may identify whether a voice command corresponding to the artificial intelligence service is obtained from audio data received through the input device 150 after the artificial intelligence service activation event occurs. As an example, the voice command corresponding to the artificial intelligence service may include a voice command matching in a table (e.g., a database) for the artificial intelligence service among at least one voice command obtained from the audio data received through the input device 150. For example, in response to obtaining a voice command corresponding to the calling of the artificial intelligence agent, the processor 120 may identify whether the voice command corresponding to the artificial intelligence service is obtained from the audio data received through the input device 150 before or after the corresponding voice command.

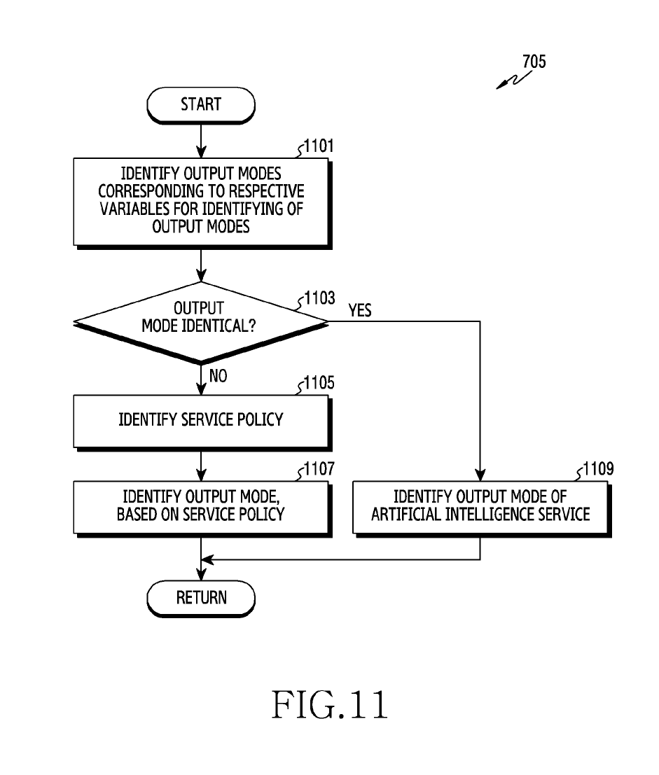

FIG. 11 illustrates a flowchart for identifying an output mode in an electronic device according to various embodiments of the present disclosure. The following description is made for an operation for identifying an output mode of the electronic device 101 for an artificial intelligence service in operation 705 of FIG. 7. In the following description, the electronic device may include the whole or at least part of the electronic device 101 of FIG. 1 or FIG. 2.

Referring to FIG. 11, in operation 1101, in response to obtaining a voice command for an artificial intelligence service, the electronic device may identify an output mode corresponding to each variable for identifying an output mode of the artificial intelligence service. For example, the processor 120 (e.g., the mode identification module 220 of FIG. 2) may identify at least one of an output mode corresponding to information (e.g., a voice command and/or a response of an agent) related with the artificial intelligence service, an output mode corresponding to a mutual relation with a counterpart electronic device or an output mode selected by a user input. As an example, in response to receiving a voice command such as “just a moment”, “wait a moment”, “I will ask and come back”, “I will ask an agent and inform you”, “I will talk with an agent alone and inform you” or the like, the processor 120 may set the output mode of the electronic device 101 as a non-public mode. As an example, in response to receiving a voice command such as “let us ask an agent”, etc., the processor 120 may set the output mode of the electronic device 101 as a public mode.

In operation 1103, the electronic device may identify whether output modes corresponding to respective variables for identifying output modes of the artificial intelligence service are identical with each other. For example, the processor 120 (e.g., the mode identification module 220 of FIG. 2) may identify whether the output mode corresponding to the information related with the artificial intelligence service and the output mode selected by the user input are identical with each other. For example, the processor 120 may identify whether the output mode corresponding to the information related with the artificial intelligence service and the output mode corresponding to the mutual relation with the counterpart electronic device are identical with each other.

In operation 1105, in response to the output modes corresponding to the respective variables for identifying the output modes of the artificial intelligence service being different from each other, the electronic device may identify a service policy of the electronic device. For example, the processor 120 (e.g., the mode identification module 220 of FIG. 2) may identify a service policy corresponding to at least one of the kind of a voice command for the artificial intelligence service or the mutual relation with the counterpart electronic device. As an example, in response to an intimacy level with the counterpart electronic device being equal to or being greater than a reference value, the processor 120 may set information sharing as the service policy of the electronic device 101. As an example, in response to the intimacy level with the counterpart electronic device being less than the reference value, the processor 120 may set personal information protection as the service policy of the electronic device 101. As an example, the intimacy level with the counterpart electronic device may be set based on at least one of the storing or non-storing of a phone number (e.g., identification information) of the counterpart electronic device in an address book of the electronic device 101, the setting or non-setting of a favorite of the phone number of the counterpart electronic device, a phone call recursion, a message transmission and/or reception recursion, a phone call time point, a message transmission and/or reception time point, a phone call time, or relation setting information (e.g., a friend, a family, etc.) with a user of the counterpart electronic device.

In operation 1107, the electronic device may identify the output mode of the electronic device for the artificial intelligence service, based on the service policy of the electronic device. For example, in response to the personal information protection being the service policy of the electronic device 101, the processor 120 (e.g., the mode identification module 220 of FIG. 2) may set an output mode whose security level is highest among the output modes corresponding to the respective variables for identifying the output mode of the artificial intelligence service, as the output mode of the electronic device 101 for the artificial intelligence service. For example, in response to information publication being the service policy of the electronic device 101, the processor 120 may set an output mode whose security level is lowest among the output modes corresponding to the respective variables for identifying the output modes of the artificial intelligence service, as the output mode of the electronic device 101 for the artificial intelligence service.

In operation 1109, in response to the output modes corresponding to the respective variables for identifying the output modes of the artificial intelligence service being identical with each other, the electronic device may set the output mode corresponding to the variable for identifying the output mode of the artificial intelligence service, as the output mode of the electronic device 101 for the artificial intelligence service.

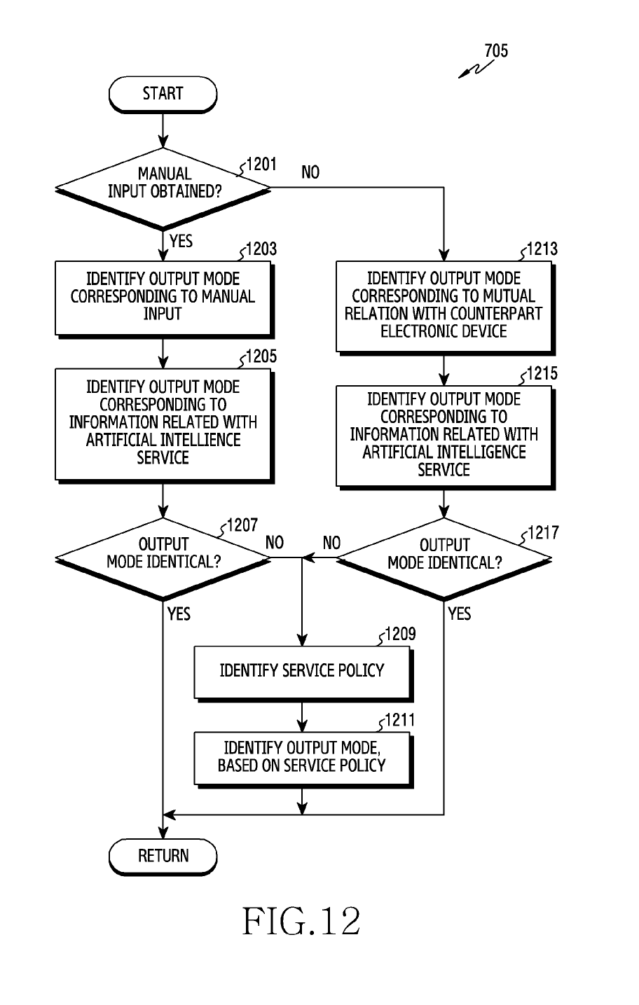

FIG. 12 illustrates a flowchart for identifying an output mode, based on a service policy in an electronic device according to various embodiments of the present disclosure. The following description is made for an operation for identifying an output mode of the electronic device 101 for an artificial intelligence service in operation 705 of FIG. 7. In the following description, the electronic device may include the whole or at least part of the electronic device 101 of FIG. 1 or FIG. 2.

Referring to FIG. 12, in operation 1201, in response to obtaining a voice command for an artificial intelligence service (e.g., operation 703 of FIG. 7), the electronic device may identify whether a manual input for selecting an output mode of the artificial intelligence service is obtained. For example, the processor 120 (e.g., the mode identification module 220 of FIG. 2) may identify whether an input of a physical button for selecting the output mode of the artificial intelligence service or a selection input of an icon is obtained.

In operation 1203, in response to the manual input for selecting the output mode of the artificial intelligence service being obtained, the electronic device may identify an output mode corresponding to the manual input. For example, the processor 120 (e.g., the mode identification module 220 of FIG. 2) may identify the output mode corresponding to the manual input, based on a scheme of input of a physical button corresponding to the artificial intelligence service. As an example, in response to the input of the physical button being obtained once, the processor 120 may identify that an output mode of the electronic device 101 for the artificial intelligence service is a mosaic mode. As an example, in response to the input of the physical button being obtained continuously twice, the processor 120 may identify that the output mode of the electronic device 101 for the artificial intelligence service is a master mode. As an example, in response to the input of the physical button being maintained for a predetermined time, the processor 120 may identify that the output mode of the electronic device 101 for the artificial intelligence service is a non-public mode.

In operation 1205, the electronic device may identify an output mode corresponding to information related with the artificial intelligence service. For example, the processor 120 (e.g., the mode identification module 220 of FIG. 2) may identify the output mode corresponding to the information related with the artificial intelligence service, based on a security level of personal information included in at least one of a voice command corresponding to the artificial intelligence service or a response of an agent. As an example, in response to the personal information not being included in the voice command corresponding to the artificial intelligence service or the response of the agent, the processor 120 may set the output mode corresponding to the information related with the artificial intelligence service, as a public mode. As an example, in response to the voice command corresponding to the artificial intelligence service needing the personal information, the processor 120 may set the output mode corresponding to the information related with the artificial intelligence service, as any one of a mosaic mode, a master mode or a non-public mode, based on a security level of the personal information that is needed by the voice command. As an example, the response of the agent may include a response of the agent which is expected based on the kind of the voice command.

In operation 1207, the electronic device may identify whether the output mode corresponding to the manual input and the output mode corresponding to the information related with the artificial intelligence service being identical with each other.

In response to the output mode corresponding to the manual input and the output mode corresponding to the information related with the artificial intelligence service being identical with each other, the electronic device may set the corresponding output mode as the output mode of the electronic device for the artificial intelligence service.

In operation 1209, in response to the output mode corresponding to the manual input and the output mode corresponding to the information related with the artificial intelligence service being different from each other, the electronic device may identify a service policy of the electronic device. For example, the processor 120 (e.g., the mode identification module 220 of FIG. 2) may set the service policy, based on at least one of the kind of a voice command for the artificial intelligence service, a mutual relation with a counterpart electronic device or a use history of the electronic device 101. For example, the service policy of the electronic device 101 may be selected based on a user input. As an example, the use history of the electronic device 101 may include at least one of an information publication object or information publication history of the electronic device 101.

In operation 1211, the electronic device may identify the output mode of the electronic device for the artificial intelligence service, based on the service policy of the electronic device. For example, the processor 120 (e.g., the mode identification module 220 of FIG. 2) may select any one output mode among the output mode corresponding to the manual input and the output mode corresponding to the information related with the artificial intelligence service, as the output mode of the electronic device 101 for the artificial intelligence service, based on the service policy of the electronic device. As an example, in response to the service policy of the electronic device 101 being personal information protection, the processor 120 may select an output mode whose security level is high. As an example, in response to the service policy of the electronic device 101 being a user selection priority, the processor 120 may select the output mode corresponding to the manual input.

In operation 1213, in response to the manual input for selecting the output mode of the artificial intelligence service not being obtained, the electronic device may identify an output mode corresponding to the mutual relation with the busy counterpart electronic device. For example, the processor 120 (e.g., the mode identification module 220 of FIG. 2) may identify the output mode corresponding to the mutual relation with the counterpart electronic device, based on an intimacy level with a user of the busy counterpart electronic device (e.g., the electronic device 104 of FIG. 1). As an example, the intimacy level may be set based on at least one of the storing or non-storing of a phone number of the counterpart electronic device, the setting or non-setting of a favorite of the phone number of the counterpart electronic device, a phone call recursion, a message transmission and/or reception recursion, a phone call time point, a message transmission and/or reception time point, a phone call time, or relation setting information with the user of the counterpart electronic device. The relation setting information may include relation information with a user of the electronic device 101 and the user of the counterpart electronic device, stored in the memory 130.

In operation 1215, the electronic device may identify the output mode corresponding to the information related with the artificial intelligence service. For example, the processor 120 (e.g., the mode identification module 220 of FIG. 2) may identify the output mode corresponding to the information related with the artificial intelligence service, based on a security level of personal information needed by the voice command corresponding to the artificial intelligence service. For example, in response to the voice command not needing a response of an agent like “Turn on TV”, the processor 120 may set a public mode as the output mode. For example, in response to storing the personal information like “I will take a voice memo”, the processor 120 may set a non-public mode as the output mode.

In operation 1217, the electronic device may identify whether the output mode corresponding to the mutual relation with the counterpart electronic device and the output mode corresponding to the information related with the artificial intelligence service are identical with each other.

In response to the output mode corresponding to the mutual relation with the counterpart electronic device and the output mode corresponding to the information related with the artificial intelligence service being identical with each other, the electronic device may set the corresponding output mode as the output mode of the electronic device for the artificial intelligence service.

In operation 1209, in response to the output mode corresponding to the mutual relation with the counterpart electronic device and the output mode corresponding to the information related with the artificial intelligence service being different from each other, the electronic device may identify the service policy of the electronic device.

In operation 1211, the electronic device may identify the output mode of the electronic device for the artificial intelligence service, based on the service policy of the electronic device. For example, the processor 120 (e.g., the mode identification module 220 of FIG. 2) may select any one output mode among the output mode corresponding to the mutual relation with the counterpart electronic device and the output mode corresponding to the information related with the artificial intelligence service, as the output mode of the electronic device 101 for the artificial intelligence service, based on the service policy of the electronic device. As an example, in response to the service policy of the electronic device 101 being information publication, the processor 120 may select an output mode whose security level is low.

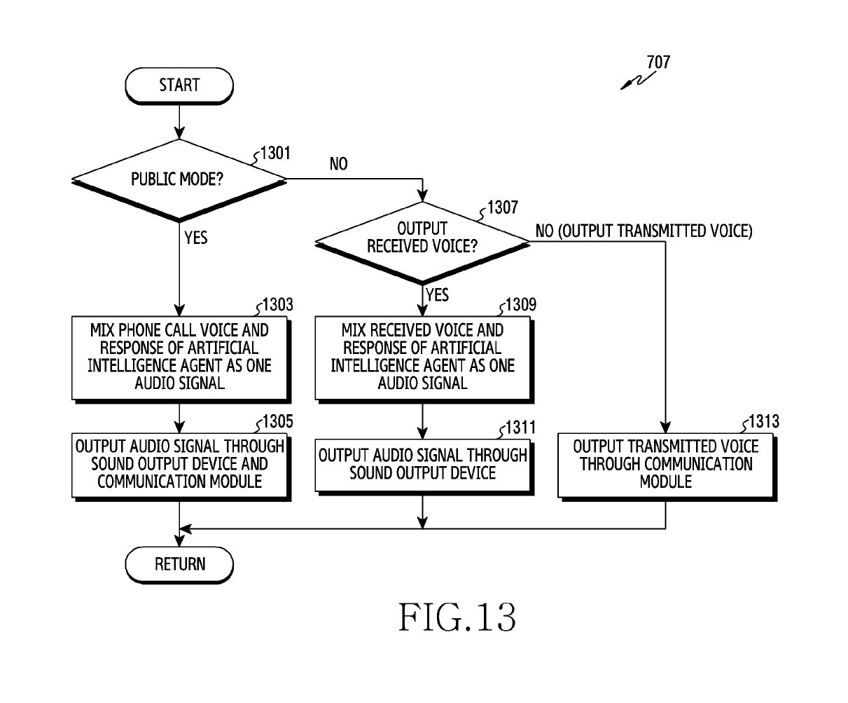

FIG. 13 illustrates a flowchart for outputting a response of an agent, based on an output mode in an electronic device according to various embodiments of the present disclosure. The following description is made for an operation for outputting the response of the agent, based on the output mode of the electronic device for an artificial intelligence service in operation 707 of FIG. 7. In the following description, the electronic device may include the whole or at least part of the electronic device 101 of FIG. 1 or FIG. 2.

Referring to FIG. 13, in operation 1301, in response to identifying an output mode of an electronic device for an artificial intelligence service (e.g., operation 705 of FIG. 7), the electronic device may identify whether the output mode of the electronic device is a public mode.

In operation 1303, in response to the output mode of the electronic device for the artificial intelligence service being the public mode, the electronic device may mix a phone call voice and a response of an artificial intelligence agent, as one audio signal. For example, in response to the output mode of the electronic device for the artificial intelligence service being the public mode, the processor 120 may control the audio mixer 230 to mix the response of the artificial intelligence agent and a voice signal received from a busy counterpart electronic device (e.g., the electronic device 104 of FIG. 1), as one audio signal. For example, in response to the output mode of the electronic device for the artificial intelligence service being the public mode, the processor 120 may control the audio mixer 230 to mix the response of the artificial intelligence agent and an audio signal received through the input device 150, as one audio signal.

In operation 1305, the electronic device may output the mixed audio signal through a sound output device and a communication module. For example, the processor 120 may control the sound output device 155 (e.g., a speaker) to output the audio signal mixed through the audio mixer 230. For example, the processor 120 may control the communication module 190 to transmit the audio signal mixed through the audio mixer 230, to a counterpart electronic device with which a phone call has been connected.

In operation 1307, in response to the output mode of the electronic device for the artificial intelligence service being a non-public mode, the electronic device may identify whether it outputs a voice received from the busy counterpart electronic device.

In operation 1309, in response to outputting an audio signal received from the busy counterpart electronic device, the electronic device may mix the audio signal received from the counterpart electronic device and a response signal of the artificial intelligence agent, as one audio signal. For example, irrespective of the output mode of the electronic device for the artificial intelligence service, the processor 120 may control the audio mixer 230 to mix the response of the artificial intelligence agent and a voice signal received from the busy counterpart electronic device (e.g., the electronic device 104 of FIG. 1), as one audio signal.

In operation 1311, the electronic device may output the mixed audio signal through the sound output device. For example, the processor 120 may control the sound output device 155 (e.g., the speaker) to output the audio signal mixed through the audio mixer 230.

In operation 1313, in response to outputting an audio signal to the busy counterpart electronic device, the electronic device may output, through the communication module, at least part of the audio signal received through the input device. For example, in response to the output mode of the electronic device for the artificial intelligence service being the non-public mode, the processor 120 may identify that it does not transmit the response of the agent to the busy counterpart electronic device. Accordingly to this, the processor 120 may control the communication module 190 to transmit at least part of the audio signal received through the input device 150 to the counterpart electronic device with which a phone call has been connected. As an example, the processor 120 may control the communication module 190 to transmit the remaining audio signal excepting at least partial audio signal related with the artificial intelligence service from the audio signal received through the input device 150. The at least partial audio signal related with the artificial intelligence service may include an audio signal that is received after an artificial intelligence service activation event takes place.

According to an embodiment, in response to the output mode of the electronic device for the artificial intelligence service being the public mode, the electronic device may identify whether personal information is included in the response of the agent. In response to the personal information being included in the response of the agent, the electronic device may identify the publication or non-publication of the personal information, based on a service policy of the electronic device. For example, in response to the service policy being set as personal information protection, the electronic device may identify that it does not open the personal information included in the response of the agent, to the public. In this case, the electronic device may batch process the personal information included in the response of the agent or replace the same with a separate sound source (e.g., a background music or beef sound). For example, in response to the service policy being set as information publication, the electronic device may identify that it opens the personal information included in the response of the agent, to the public.

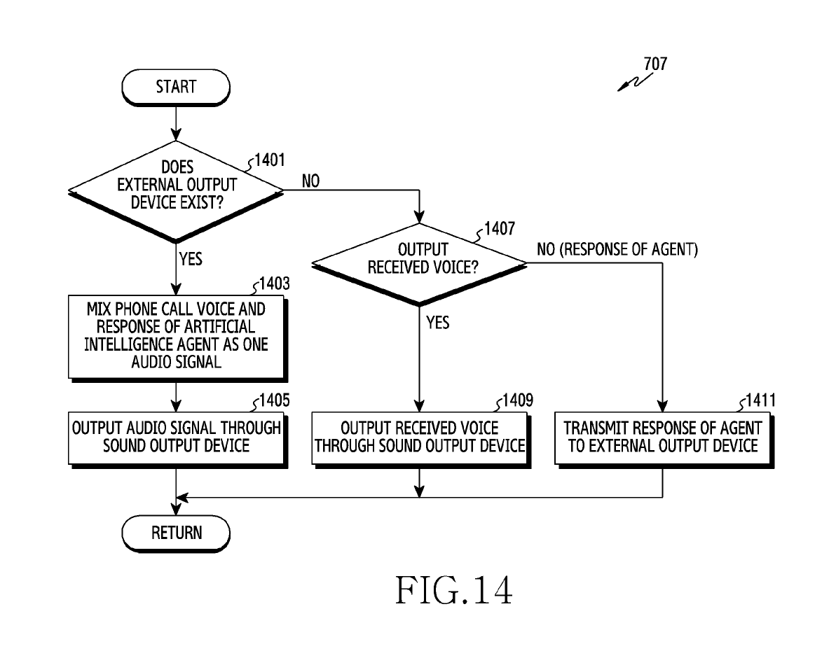

FIG. 14 illustrates a flowchart for outputting a response of an agent by using an external output device in an electronic device according to various embodiments of the present disclosure. The following description is made for an operation of outputting the response of the agent, based on an output mode of the electronic device for an artificial intelligence service in operation 707 of FIG. 7. In the following description, the electronic device may include the whole or at least part of the electronic device 101 of FIG. 1 or FIG. 2.

Referring to FIG. 14, in operation 1401, in response to identifying an output mode of the electronic device for an artificial intelligence service (e.g., operation 705 of FIG. 7), the electronic device may identify whether an external output device capable of being operatively coupled with the electronic device exists. For example, the processor 120 may identify whether the external output device whose communication is connected with the electronic device 101 exists. For example, the processor 120 may control the communication module 190 to transmit a control signal (e.g., a beacon message) for identifying whether the external output device adjacent to the electronic device 101 exists. The processor 120 may identify whether the external output device capable of being coupled with the electronic device 101 exists, based on a response signal responsive to the control signal. As an example, the external output device may include an external speaker device.

In operation 1403, in response to the external output device capable of being operatively coupled with the electronic device not existing, the electronic device may mix a phone call voice signal and a response signal of an artificial intelligence agent, as one audio signal. For example, irrespective of an output mode of the electronic device 101 for an artificial intelligence service, the processor 120 may control the audio mixer 230 to mix the response signal of the artificial intelligence agent and an audio signal received from a busy counterpart electronic device (e.g., the electronic device 104 of FIG. 1), as one audio signal.

In operation 1405, the electronic device may output the mixed audio signal through the sound output device. For example, the audio signal mixed through the audio mixer 230 may be outputted through the sound output device 155 (e.g., the speaker).

In operation 1407, in response to the external output device capable of being operatively coupled with the electronic device existing, the electronic device may identify whether it outputs an audio signal received from the busy counterpart electronic device.

In operation 1409, in response to outputting the audio signal received from the busy counterpart electronic device, the electronic device may output the audio signal received from the counterpart electronic device through a sound output device. For example, the processor 120 may control the sound output device 155 (e.g., the speaker) to output the audio signal received from the counterpart electronic device through the communication module 190.

In operation 1411, in response to outputting a response signal of the agent, the electronic device may transmit the response signal of the agent to the external output device. For example, the processor 120 may control the communication module 190 to transmit, to the external output device, audio data corresponding to a voice command received from the artificial intelligence agent (e.g., the server 108 of FIG. 1). As an example, the external output device may output the audio data provided from the electronic device.

According to an embodiment, in response to a plurality of external output devices existing, the electronic device may select an external output device for outputting a response signal of an artificial intelligence agent, based on a distance with the electronic device. For example, the processor 120 may select at least one external output device whose distance with the electronic device 101 is most adjacent among the plurality of external output devices capable of being operatively coupled with the electronic device 102. Additionally, the processor 120 may select the external output device for outputting the response signal of the artificial intelligence agent, based on an output state of the external output device. As an example, the processor 120 may identify whether an external output device not outputting an audio signal among the plurality of external output devices capable of being operatively coupled with the electronic device 102 exists. The processor 120 may select at least one external output device whose distance with the electronic device 101 is most adjacent among at least one external output device not outputting an audio signal.

According to an embodiment, in response to including a plurality of microphones, the electronic device may receive an audio signal for an artificial intelligence service by using a microphone different from a microphone used for a phone call.

According to an embodiment, in response to including a plurality of speakers, the electronic device may output a response signal of an agent for an artificial intelligence service by using a speaker different from a speaker outputting an audio signal for a phone call.

According to various embodiments of the present disclosure, in response to the external output device capable of being operatively coupled with the electronic device including a display device, the electronic device may output graphic data corresponding to an artificial intelligence service through the display device of the external output device. For example, the processor 120 may control the communication module 190 to transmit, to the external output device, graphic data corresponding to a voice command received from the artificial intelligence agent (e.g., the server 108 of FIG. 1). The external output device may display the graphic data received from the electronic device through the display device.

According to various embodiments of the present disclosure, a method for operating in an electronic device may include connecting a call with another electronic device, and in response to receiving a voice command for an artificial intelligence service, identifying an output mode, based on at least one of information related with the artificial intelligence service or mutual relation information with the another electronic device, and outputting a response signal corresponding to the voice command, based on the output mode.

According to various embodiments, identifying the output mode may include identifying the output mode, based on at least one of personal information included in the information related with the artificial intelligence service or the existence or non-existence of the response signal corresponding to the voice command.

According to various embodiments, the information related with the artificial intelligence service may include at least one of the voice command for the artificial intelligence service or the response signal corresponding to the voice command.

According to various embodiments, identifying the output mode may include identifying the output mode, based on an intimacy level with a user of the other electronic device.

According to various embodiments, the intimacy level with the user of the another electronic device may be set based on at least one of the storing or non-storing of a phone number of the another electronic device, the setting or non-setting of a favorite of the phone number of the another electronic device, a phone call recursion, a message transmission and/or reception recursion, a phone call time point, a message transmission and/or reception time point, a phone call time, or relation setting information with the user of the another electronic device.

According to various embodiments, identifying the output mode may include, in response to an output mode corresponding to the information related with the artificial intelligence service and an output mode corresponding to the mutual relation information with the another electronic device being different from each other, identifying a service policy of the electronic device, and selecting any one of the output mode corresponding to the information related with the artificial intelligence service and the output mode corresponding to the mutual relation information with the another electronic device, as the output mode of the electronic device, based on the service policy.

According to various embodiments, the service policy may be identified based on at least one of the kind of the voice command, the mutual relation information with the other electronic device, or a use history of the electronic device.

According to various embodiments, outputting the response signal corresponding to the voice command may include mixing the response signal corresponding to the voice command and an audio signal received from the another electronic device, and outputting the mixed audio signal through a sound output device operatively coupled with the electronic device.

According to various embodiments, outputting the response signal corresponding to the voice command may include, in response to the output mode being a public mode, mixing at least part of the response signal corresponding to the voice command and an audio signal received through the at least one microphone, and transmitting the mixed audio signal to the another electronic device.

According to various embodiments, outputting the response signal corresponding to the voice command may include, in response to the output mode being a non-public mode, transmitting at least part of an audio signal, which is received through at least one microphone operatively coupled with the electronic device, to the another electronic device.

Meantime, a description has been made for various embodiments of the present disclosure, but various modifications may be made within a limit not departing from the scope of the various embodiments of the present disclosure. Therefore, the scope of the various embodiments of the present disclosure should not be limited and defined to the described embodiment and should be defined by not only claims described later but also the equivalents to these claims.

An electronic device and an operating method thereof according to various embodiments may provide an artificial intelligence service by activating an artificial intelligence agent, based on a user input (e.g., a voice command, a physical button input, etc.) during a voice call with a counterpart electronic device, thereby easily providing various functions during a phone call by using the artificial intelligence agent.

An electronic device and an operating method thereof according to various embodiments may protect personal information about a user of the electronic device, by identifying an output mode of an artificial intelligence service, based on information (e.g., a voice command and/or a response of an agent) related with the artificial intelligence service and a mutual relation with a counterpart electronic device, during a voice call with the counterpart electronic device.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a communication module:
at least one processor; and
a memory,
wherein the at least one processor is operably connected to the communication module and the memory, and configured to:
connect a call with another electronic device through the communication module;
in response to receiving a voice command for an artificial intelligence service, identify an output mode, based on at least one of information related with the artificial intelligence service or mutual relation information with the other electronic device; and
output a response signal corresponding to the voice command, based on the output mode.

2. The electronic device of claim 1, wherein the at least one processor is further configured to:
identify the output mode, based on at least one of personal information comprised in the information related with the artificial intelligence service, whether the response signal corresponding to the voice command exists, or whether the response signal corresponding to the voice command does not exist.

3. The electronic device of claim 2, wherein the information related with the artificial intelligence service comprises at least one of the voice command for the artificial intelligence service or the response signal corresponding to the voice command.

4. The electronic device of claim 1, wherein the at least one processor is further configured to:
identify the output mode, based on an intimacy level with a user of the other electronic device.

5. The electronic device of claim 4, wherein the intimacy level with the user of the other electronic device is set based on at least one of:
whether a phone number of the other electronic device is stored in the memory,
whether a favorite of the phone number of the other electronic device is set,
a phone call recursion,
a message transmission or reception recursion,
a phone call time point,
a message transmission or reception time point,
a phone call time, or
relation setting information with the user of the other electronic device.

6. The electronic device of claim 1, wherein the at least one processor is further configured to:
in response to an output mode corresponding to the information related with the artificial intelligence service and an output mode corresponding to the mutual relation information with the other electronic device being different from each other, select any one of the output mode corresponding to the information related with the artificial intelligence service and the output mode corresponding to the mutual relation information with the other electronic device, as the output mode of the electronic device, based on a service policy of the electronic device.

7. The electronic device of claim 6, wherein the service policy is identified based on at least one of a type of the voice command, the mutual relation information with the other electronic device, or a use history of the electronic device.

8. The electronic device of claim 1, further comprising an audio mixer,
wherein the at least one processor is further configured to:
control the audio mixer to mix the response signal corresponding to the voice command and an audio signal received from the other electronic device through the communication module, and
control the audio mixer to selectively mix the response signal corresponding to the voice command and an audio signal received through at least one microphone of the electronic device, based on the output mode.

9. The electronic device of claim 8, wherein the at least one processor is configured to:
in response to the output mode being a public mode, control the audio mixer to mix at least part of the response signal corresponding to the voice command and an audio signal received through the at least one microphone, and control the communication module to transmit the mixed audio signal to the other electronic device; and
in response to the output mode being a non-public mode, restrict the audio mixer from mixing the response signal corresponding to the voice command and the audio signal received through the at least one microphone, and control the communication module to transmit at least part of the audio signal received through the at least one microphone to the other electronic device.

10. The electronic device of claim 1, wherein the at least one processor is further configured to:
transmit the response signal corresponding to the voice command to an external output device operatively coupled with the electronic device; and
output, through at least one sound output device of the electronic device, an audio signal that is received from the other electronic device through the communication module.

11. A method for operating in an electronic device, the method comprising:
connecting a call with another electronic device;
in response to receiving a voice command for an artificial intelligence service, identifying an output mode, based on at least one of information related with the artificial intelligence service or mutual relation information with the other electronic device; and
outputting a response signal corresponding to the voice command, based on the output mode.

12. The method of claim 11, wherein identifying the output mode comprises identifying the output mode, based on at least one of personal information comprised in the information related with the artificial intelligence service, whether the response signal corresponding to the voice command exists, or whether the response signal corresponding to the voice command does not exist.

13. The method of claim 12, wherein the information related with the artificial intelligence service comprises at least one of the voice command for the artificial intelligence service or the response signal corresponding to the voice command.

14. The method of claim 11, wherein identifying the output mode comprises identifying the output mode, based on an intimacy level with a user of the other electronic device.

15. The method of claim 14, wherein the intimacy level with the user of the other electronic device is set based on at least one of:
whether a phone number of the other electronic device is stored,
whether a favorite of the phone number of the other electronic device is set,
a phone call recursion,
a message transmission or reception recursion,
a phone call time point,
a message transmission or reception time point,
a phone call time, or
relation setting information with the user of the other electronic device.

16. The method of claim 11, wherein identifying the output mode comprises:
in response to an output mode corresponding to the information related with the artificial intelligence service and an output mode corresponding to the mutual relation information with the other electronic device being different from each other, identifying a service policy of the electronic device; and
selecting any one of the output mode corresponding to the information related with the artificial intelligence service and the output mode corresponding to the mutual relation information with the other electronic device, as the output mode of the electronic device, based on the service policy.

17. The method of claim 16, wherein the service policy is identified based on at least one of a type of the voice command, the mutual relation information with the other electronic device, or a use history of the electronic device.

18. The method of claim 11, wherein outputting the response signal corresponding to the voice command comprises:
mixing the response signal corresponding to the voice command and an audio signal received from the other electronic device; and
outputting the mixed audio signal through a sound output device of the electronic device operatively coupled with the electronic device.

19. The method of claim 11, wherein outputting the response signal corresponding to the voice command comprises:
in response to the output mode being a public mode, mixing at least part of the response signal corresponding to the voice command and an audio signal received through at least one microphone of the electronic device; and
transmitting the mixed audio signal to the other electronic device.

20. The method of claim 11, wherein outputting the response signal corresponding to the voice command comprises, in response to the output mode being a non-public mode, transmitting at least part of an audio signal that is received through at least one microphone of the electronic device, to the other electronic device.
